(19) United States
(12) Patent Application Publication
(10) Pub. No.: US 2007/0110032 A1
(43) Pub. Date: May 17, 2007

(54) DSL prospecting system and method

(75) Inventors: Donald Eric Pimpler, San Antonio, TX (US); Eric Cabading, Spring Branch, TX (US); Kenneth L. Tysell, San Antonio, TX (US)

Correspondence Address: PAUL S MADAN;MADAN, MOSSMAN & SRIRAM, PC, 2603 AUGUSTA, SUITE 700, HOUSTON, TX, 77057-1130, US

(73) Assignee: SBC Knowledge Ventures L.P., Reno, NV (US)

(21) Appl. No.: 11/280,108

(22) Filed: Nov. 16, 2005

(51) Int. Cl. H04L 12/66

(52) U.S. Cl. 370/352

(57) ABSTRACT

This disclosure provides visual representation of spatially correlated customer and communication networks service distribution areas. A method is provided wherein customer data is geocoded, and spatially enabled. Maps are generated that depict customer subscribe in service distribution areas in a selected geographical region for a plurality of regions. Visual representations of customer market statistics and placement of network equipment also are provided.

### BACKGROUND OF THE DISCLOSURE

1. Field of the Disclosure

The present disclosure relates to the field of Digital Subscriber Line Services.

2. Background

Service providers deploy communications network to provide digital subscriber line (DSL) services, such as internet access, voice over the internet protocol (VoIP) and internet protocol television (IPTV), etc. DSL services are wire length limited and thus, the network is typically divided into multiple wire centers, each wire center providing services within a region. The wire center is often further subdivided into distribution areas. A central office housing network equipment often is utilized for each wire center. Remote terminals also are provided to provide the services and to extend the service reach. Network equipment, such as digital subscriber line access multiplexers (DSLAM) is typically located at a central office serving the wire center. DSLAMs provide a dedicated connection to each customer. Many such connections exist even though the customers connected thereto are not subscribers of a DSL service. It is desirable to provide a system and method that can provide an effective way to identify customers, placement of the deployed and planned equipment, and customers that may be targeted for the network services.

### BRIEF DESCRIPTION OF THE DRAWINGS

For detailed understanding of the illustrative embodiment, references should be made to the following detailed description of an illustrative embodiment, taken in conjunction with the accompanying drawings, in which like elements have been given like numerals and wherein:

FIG. 1 is a functional block diagram of an exemplary system according to an embodiment of the present disclosure;

FIG. 2 is an exemplary snapshot showing wire center boundaries in a selected region;

FIG. 3 is an exemplary snapshot showing service distribution areas within a selected wire center;

FIG. 4 is an exemplary snapshot of a map showing customers by subscriber status, service distribution areas and deployment of network services;

FIG. 5 is an exemplary snapshot showing a visualization of a network statistic;

FIG. 6 is an exemplary snapshot showing a customer status list for a selected region;

FIG. 7 is a flowchart showing an exemplary method for geocoding and spatially enabling customer data; and

FIG. 8 is a diagramic representation of a machine in the form of a computer within which a set of instructions, when executed, may cause the machine to one or more of the methodologies of the present disclosure.

### DETAILED DESCRIPTION OF THE ILLUSTRATIVE EMBODIMENTS

In view of the above, the present disclosure through one or more of its various aspects and/or embodiments is presented to provide one or more advantages, such as those noted below.

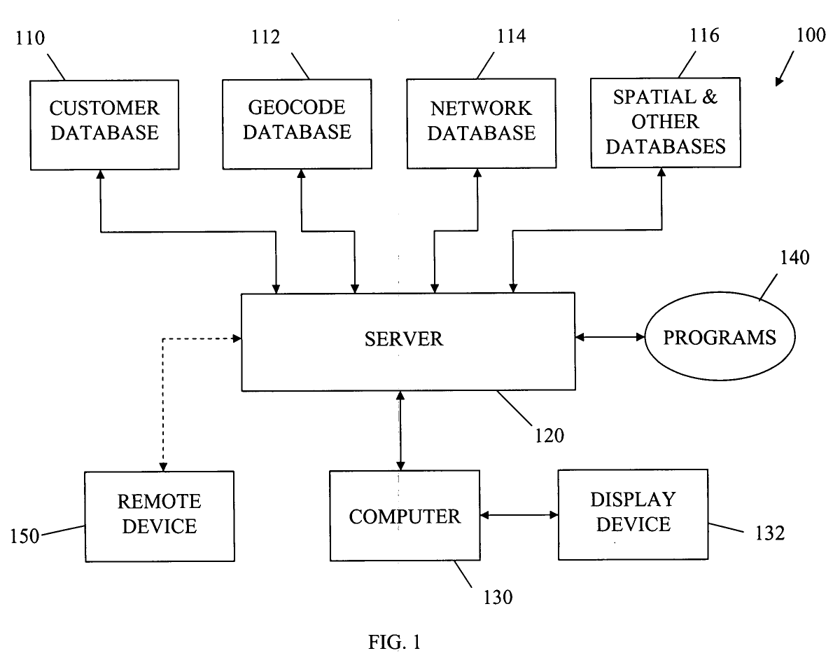

FIG. 1 shows a functional block diagram of an exemplary system 100 according to one embodiment of the present disclosure. The system of 100 includes a plurality of databases. A customer database 110, typically generated by the service provider marketing group, may include information about customers in the geographical regions where the service provider is providing or intends to provide the DSL services. Such services may include internet access service, voice over the internet protocol (VoIP) service, and internet protocol television (IPTV) service. The customer database 110 includes information about each customer in a plurality of geographical regions. The data includes information, such as the name, street address, subdivision, postal zip or wire center code, subscriber status (i.e., whether the customer has subscribed to a service), the charges for the services, revenue, payment history of the customer, credit rating and status of the customer with the subscriber (e.g. an unwanted customer, desirable customer, etc).

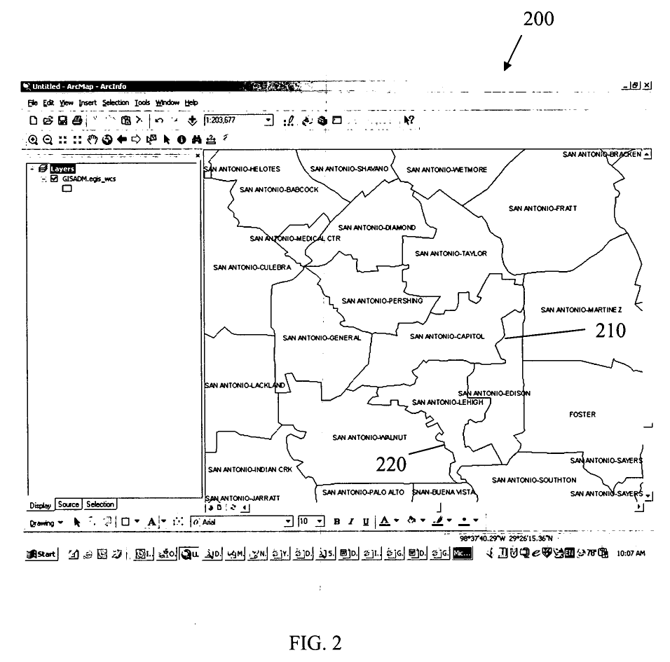

The system 100 further includes a geocode information database 112 that contains the geodedic information, such as the latitude and the longitude that correspond to each customer address. The system 100 further includes a network database 114. The network database includes data that defines wire center boundaries of the DSL communications network, distribution area (DA) boundaries within each wire center and the equipment location areas for each of the wire centers and the distribution area. DSL is a distance sensitive service, usually limited to about 18,000 feet from digital subscriber line access multiplexers (DSLAMs). Therefore, the service providers establish wire centers as the basic units of telecommunications geography as shown and described below in reference to FIG. 2. A wire center is typically serviced by a single central office where subscriber lines are connected to a local switching equipment, such as the DSLAMs. DSLAM is a known device in the telecommunications art and is a device that provides a dedicated connection to multiple customers, often more than 200. At the customer end, DSLAM is connected to the customer premise via intermediate connections and at the server side to the network backbone that transmits the DSL service contents. At a finer level, each wire center typically is composed of one or more distribution areas (DAs). DSL services are usually first deployed to those DA's that are within the maximum acceptable distance from the central office, and later to DA's referred to as remote terminals (RT). A remote terminal is generally any switch or routing equipment that is located outside the central office. An RT is typically linked back to the central office through a fiber optic cable. RT's can be utilized to extend the service reach beyond the maximum acceptable wire distance. The network database 116 further includes information relating to the location of the central offices and the areas serviced by the central offices, location and areas serviced by each remote terminal, equipment at each central office and the remote terminal, and loop length. The system 100 further may include one or more other databases 116, such as a database that spatially enables geocoded customer database to provide visual displays in the form of maps.

The system 100 further includes a server 120 that has access to each of the databases 110, 112, 114 and 116. The system 100 further includes computer programs 140 that are accessible to the server 120. The server executes instructions contained in the computer programs and performs one or more of the functions described herein and generates one or more results described herein. A computer 130 may be coupled to the server 120 to interact with the server and display the results on a display device 132. Alternatively, a remote device 150 may be utilized to perform the functions of the computer 130. The remote device 150 may have access to the server via an internet and/or a wireless network. An operator, utilizing the computer 130 or a remote device 150, may log in by entering an assigned personal identification number (PIN) and display one or more results contemplated by the present disclosure.

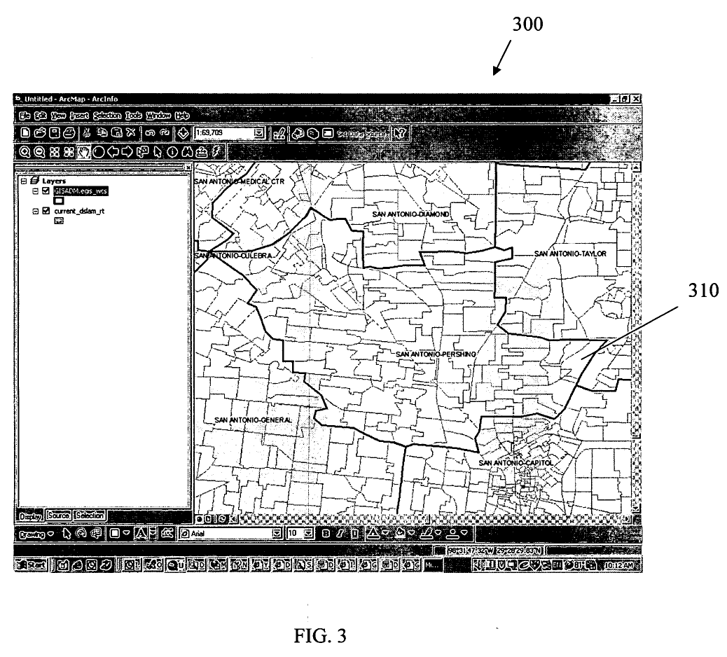

In one aspect, as shown in FIG. 2, the system 100 generates a visual map 200 of the wire center boundaries in a selected geographical region. For example, line 210 defines the boundary of a “San Antonio-Capital” wire center while line 220 defines the boundary of a “San Antonio-Wallnut” wire center. In another aspect and as shown in FIG. 3, the system 100 further generates a visual map that displays the boundaries of the distribution areas within each wire center. FIG. 3 shows an exemplary snapshot 300 of the boundary of the wire center “San Antonio-Pershing” and the boundaries of the various distribution areas within such wire center, such as a distribution area 310.

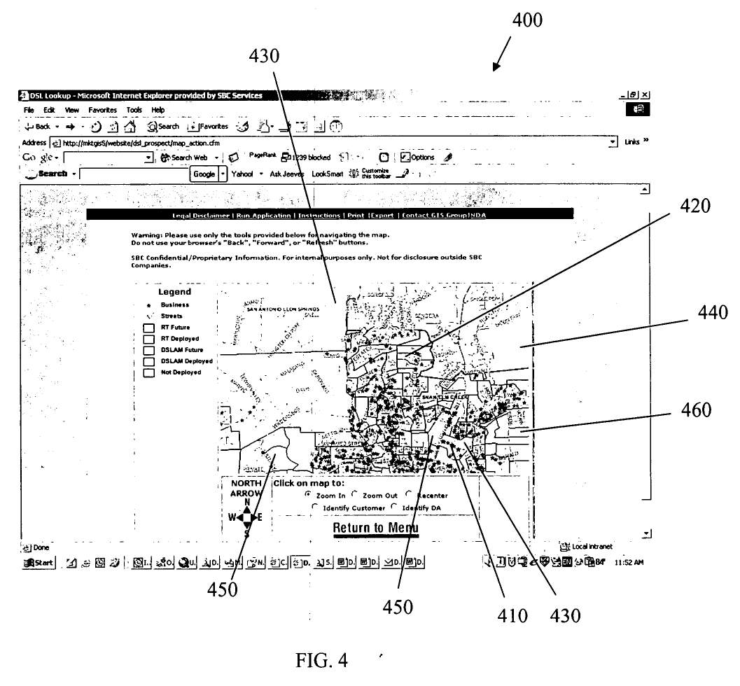

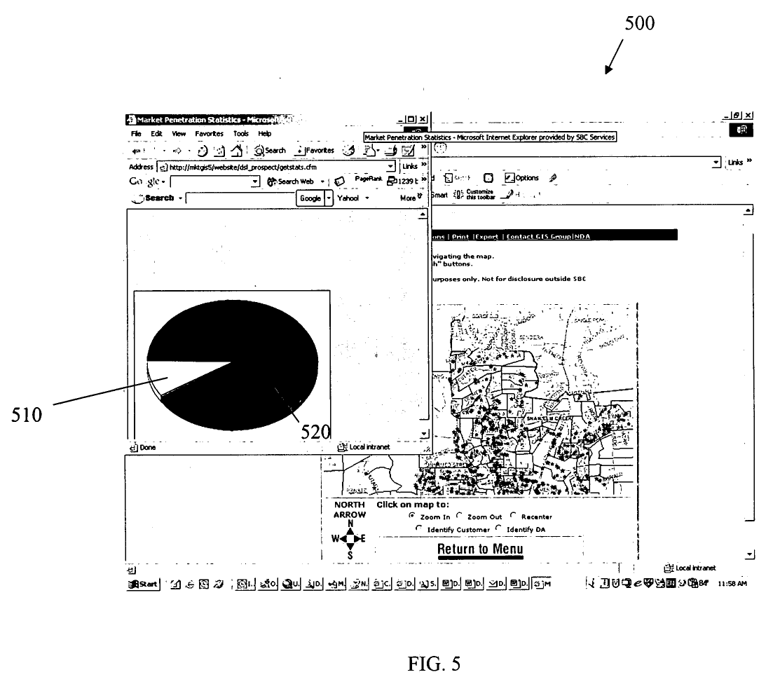

As shown in FIG. 4, the system 100, in another aspect, generates a visual map for each geographical area, such as map 400 that displays customer and network information within each wire center and the distribution area. The map 400 displays or identifies by a color dot location of each customer who is a subscriber of an offered DSL service and each customer who is not a subscriber. Dots 410 indicate the subscribers while dots 420 indicate non subscribers. These dots may be of different color or shapes. The map 400 further identifies the areas 430 for future deployment of RTs; areas 440 for future or planned deployment of DSLAM's, areas 450 where DSLAM's are currently deployed and areas 460 where there is no current or planned deployment of the DSL services. The system 100 can generate and display a separate map for residential customers and business customers. The system further enables an operator, utilizing the computer 140 or the remote device 150, to enlarge the map or focus the view to any customer within the area of the map 400. The system 100 further generates statistical information about the customers in any distribution area. For example, snapshot shown in FIG. 5 depicts market penetration statistics of percent of customers 510 who have subscribed to an available service and customers 520 who are not subscribers and may be targeted for marketing and other purposes.

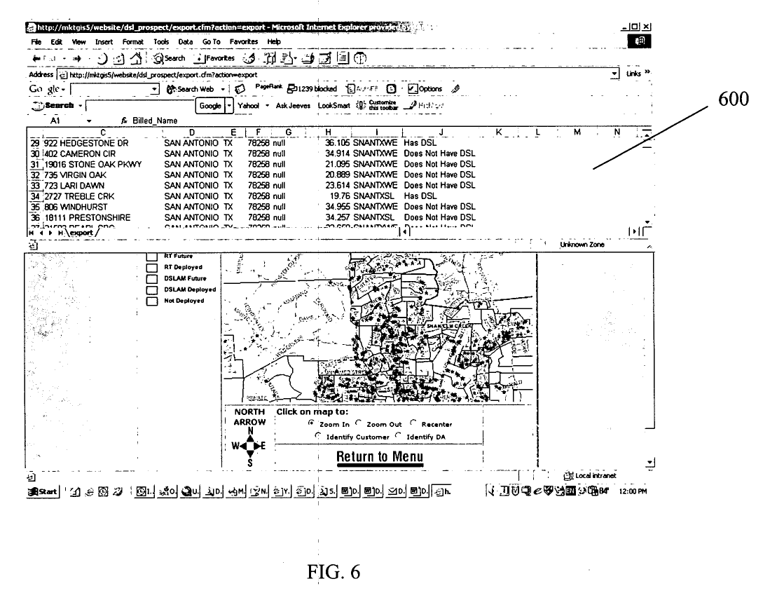

As shown in FIG. 6, the system 100 also generates a customer list, which may be in a spreadsheet form, that shows the street address of each customer in a selected area and the customer status i.e., a subscriber or not a subscriber of the DSL service. Thus, the system 100 provides a visual display where the DSL services have been deployed; a visual display of how the DSL services have been deployed i.e. DSLAM's, RT's etc.; a visual display of geocoded customer information (business and residential) in relation to the DSL deployment status of individual distribution areas; access to individual customer information, including name, address, type of service subscribed, revenue, DSL subscription status, market penetration statistics; identification of areas that would be responsive to marketing efforts and ability to download and display the information from a remote device. The system 100 further generates a revenue for targeted customers in any area. In one aspect, the revenue may be computed as the number of potential subscribers times the service charge for each targeted service. The system further may compute the cost of providing the service to the targeted customers. The costs may include the cost of the equipment and the cost for providing the service. The system then can identify areas for the deployment of DSL services, including the deployment of DSLAMs, RTs and other equipment, based on the revenue and costs.

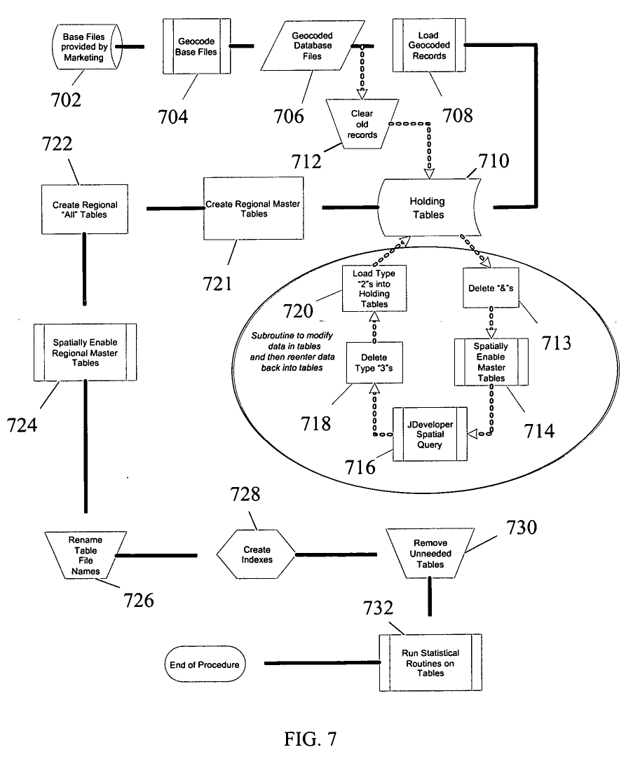

FIG. 7 shows a flow chart depicting an exemplary method or procedure 700 for geoprocessing customer data according to one embodiment of the disclosure. Customer database 702 in the form of customer files and the geocode database in the form of geocode files 704 are processed to obtain a geocoded customer database or files 706. Each geocode file contains customer information, such as the name, address information, latitude, longitude, match code, btn, loop length, existence of a DSL service, subscriber status, revenue, revenue type, and customer status with the service provider, etc.

At this point there may be multiple master geocoded files. For example, if the network services are divided into four regions, each region further having different types of customers, e.g. residential and business, then there may be eight such master files, one for each region by the customer type. At block 708 the geocoded files are loaded into holding tables 710. The holding tables 710 may be part of a data structure, such as provided by Oracle Corporation. Any unwanted records, may be removed from the geocoded database files as shown at block 712. Any unwanted characters in the tables are deleted as shown at block 713. An unwanted character may be an “&” in the billed_name field of a customer. Once the data files are clean, the master tables are spatially enabled as shown at block 714. After spatial query is done at block 716 and deleting type 3's at block 718, potential customers may be added into the tables. Thus, the holding tables become spatially enabled tables. The Regional Master tables (by each region & customer type) are then created as shown at block 721. At block 722, old records in the regional “all” tables are cleared and new business and residential customer tables are combined into regional tables to generate a regional “all” table. At block 724, regional master and “all” tables are then spatially enabled. At block 726, the table files are renamed so that the newly created files may be used in any query. At block 728, indexes are created for improving query run-time speed. At block 730, unneeded tables that have been used for geoprocessing are deleted. Statistical routines can be run on the tables to provide statistical results at block 732.

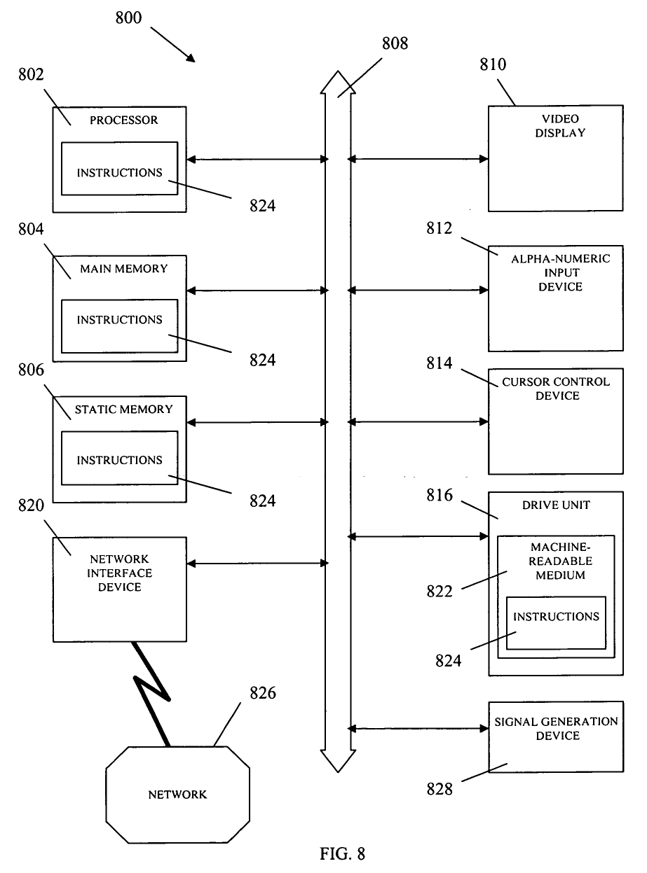

Turning now to FIG. 8, FIG. 8 is a diagrammatic representation of a machine in the form of a computer system 800 within which a set of instructions, when executed, may cause the machine to perform any one or more of the methodologies discussed herein. In some embodiments, the machine operates as a standalone device. In some embodiments, the machine may be connected (e.g., using a network) to other machines. In a networked deployment, the machine may operate in the capacity of a server or a client user machine in server-client user network environment, or as a peer machine in a peer-to-peer (or distributed) network environment. The machine may comprise a server computer, a client user computer, a personal computer (PC), a tablet PC, a set-top box (STB), a Personal Digital Assistant (PDA), a cellular telephone, a mobile device, a palmtop computer, a laptop computer, a desktop computer, a personal digital assistant, a communications device, a wireless telephone, a land-line telephone, a control system, a camera, a scanner, a facsimile machine, a printer, a pager, a personal trusted device, a web appliance, a network router, switch or bridge, or any machine capable of executing a set of instructions (sequential or otherwise) that specify actions to be taken by that machine. It will be understood that a device of the present invention includes broadly any electronic device that provides voice, video or data communication. Further, while a single machine is illustrated, the term “machine” shall also be taken to include any collection of machines that individually or jointly execute a set (or multiple sets) of instructions to perform any one or more of the methodologies discussed herein.

The computer system 800 may include a processor 802 (e.g., a central processing unit (CPU), a graphics processing unit (GPU), or both), a main memory 804 and a static memory 806, which communicate with each other via a bus 808. The computer system 800 may further include a video display unit 810 (e.g., a liquid crystal display (LCD), a flat panel, a solid state display, or a cathode ray tube (CRT)). The computer system 800 may include an input device 812 (e.g., a keyboard), a cursor control device 814 (e.g., a mouse), a disk drive unit 816, a signal generation device 818 (e.g., a speaker or remote control) and a network interface device 820.

The disk drive unit 816 may include a machine-readable medium 822 on which is stored one or more sets of instructions (e.g., software 824) embodying any one or more of the methodologies or functions described herein, including those methods illustrated in herein above. The instructions 824 may also reside, completely or at least partially, within the main memory 804, the static memory 806, and/or within the processor 802 during execution thereof by the computer system 800. The main memory 804 and the processor 802 also may constitute machine-readable media. Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present invention, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present invention contemplates a machine readable medium containing instructions 824, or that which receives and executes instructions 824 from a propagated signal so that a device connected to a network environment 826 can send or receive voice, video or data, and to communicate over the network 826 using the instructions 824. The instructions 824 may further be transmitted or received over a network 826 via the network interface device 820.

While the machine-readable medium 822 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. The term “machine-readable medium” shall accordingly be taken to include, but not be limited to: solid-state memories such as a memory card or other package that houses one or more read-only (non-volatile) memories, random access memories, or other re-writable (volatile) memories; magneto-optical or optical medium such as a disk or tape; and carrier wave signals such as a signal embodying computer instructions in a transmission medium; and/or a digital file attachment to e-mail or other self-contained information archive or set of archives is considered a distribution medium equivalent to a tangible storage medium. Accordingly, the invention is considered to include any one or more of a machine-readable medium or a distribution medium, as listed herein and including art-recognized equivalents and successor media, in which the software implementations herein are stored.

What is claimed is:

1. A method, comprising:
providing customer information for a plurality of customers for each of a plurality of geographical regions, the customer information including an address and a subscriber status relating to a network service for each said customer;
providing service distribution areas associated with each of the geographical regions;
geocoding the customer information;
spatially correlating the geocoded customer information and service distribution areas;
generating from the spatially correlated information a visual map identifying the customers by the subscriber status within the service distribution areas for a selected geographical region from the plurality of the geographical regions.

2. The method of claim 1, wherein identifying the customers further comprises separately identifying on the map the customers who are subscribers of the network service and those who are not subscribers of the network service.

3. The method of claim 1 further comprising identifying customers in the selected geographical area where no network service is available.

4. The method of claim 3 further comprising estimating a revenue opportunity for the customers where no network service is available.

5. The method of claim 4 further comprising identifying a location for placement of network resources if the revenue meets a set criterion.

6. The method of claim 1 further comprising providing a spread sheet that identifies the address and the subscriber status of each customer in the selected geographical region.

7. The method of claim 2 further comprising providing a market penetration statistic relating to the customers who are not subscribers in the selected geographical area.

8. A system, comprising:
a customer database for storing a customer address and a customer subscriber status for a network service for a plurality of customers for each geographical region in a plurality of geographical regions;
a geocode database for storing a geocode for each of the plurality of customers;
a network database for storing network service distribution areas associated with each geographical region;
a processor;
a computer readable medium accessible to the processor;
a computer program embedded within the computer readable medium, the computer program comprising:
instructions to geocode the customer information;
instructions to spatially enable the geocoded customer information; and
instructions to display a map that identifies each network service distribution area associated with a selected geographical region from the plurality of regions and each customer in each distribution area by a subscriber status.

9. The system of claim 8, wherein the computer program further comprises instructions to separately identify on the map customers who are subscribers of the service and the customers who are not subscribers of the service.

10. The system of claim 8, wherein the computer program further comprises instructions to identify sections of the selected geographical area with no associated network service distribution areas.

11. The system of claim 10, wherein the computer program further comprises instructions to estimate a revenue opportunity for a section of the selected geographical area with no associated service distribution areas.

12. The system of claim 9, wherein the computer program further comprises instructions to estimate revenue for customers who are not subscribers of the service.

13. The system of claim 8, wherein the computer program further comprises instructions to provide a spread sheet that identifies the address and the subscriber status of each customer in the selected geographical region.

14. The system of claim 9, wherein the computer program further comprises instructions to provide a market penetration statistic relating to the customers who are not subscribers of the network service in the selected geographical area.

15. The system of claim 8, wherein the computer program further comprises instructions to identify a network equipment on the map.

16. The system of claim 8, wherein the computer program further comprises instructions to provide access to the map from a remote device.

17. A computer readable medium accessible to a processor, comprising:
a computer program embedded within the computer readable medium, the computer program comprising:
instructions to geocode customer addresses of a plurality of customers in a plurality of network distribution areas;
instructions to spatially enable the geocoded customer addresses; and
instructions to generate a map that identifies each customer in each of the network distribution areas by a customer status relating to a network service.

18. The computer readable medium of claim 17, wherein the computer program further comprises instructions to identify each network distribution area where the network service is deployed.

19. The computer readable medium of claim 18, wherein the computer program further comprises instructions to identify each customer who is not a subscriber.

20. The computer readable medium of claim 19, wherein the computer program further comprises instructions to generate a market statistic relating to targeting customers for the network service.
